(19) United States
(12) Patent Application Publication
(10) Pub. No.: US 2024/0383168 A1
(43) Pub. Date: Nov. 21, 2024

(54) ROUND BAR CUTTING DEVICE

(71) Applicant: SUPER POWER TOOLS CO., LTD., Taichung City (TW)

(72) Inventor: Yu-Chun LIU, Taichung City (TW)

(21) Appl. No.: 18/317,194

(22) Filed: May 15, 2023

(51) Int. Cl. B27C 5/08; B27C 7/00; B27C 7/04

(52) U.S. Cl. CPC B27C 5/08; B27C 7/005; B27C 7/04

(57) ABSTRACT

A round bar cutting device includes a tool rest that is penetrated by a perforation for a round bar to pass through in axial direction. A virtual axis is defined to pass through the radial center of the perforation in the extension direction of the perforation. Four planer tools protrude from the tool rest. The planer tools are spaced apart around the axis as the center. A first edge is formed on one side of the planer tools towards the axis respectively, so as to cut a square bar which moves towards the perforation among the planer tools and rotates round the axis to form the round bar. The cutting device can fully cut the entire section of the square bar in the axial direction into the round bar, and the material utilization efficiency of the square bar is increased.

### CROSS-REFERENCE TO RELATED U.S. APPLICATIONS

Not applicable.

### BACKGROUND OF THE INVENTION

### 1. Field of the Invention

The present invention relates generally to a tool for woodworking, and more particularly to a round bar cutting device capable of cutting a square bar into a round bar.

### 2. Description of Related Art Including Information Disclosed Under 37 CFR 1.97 and 37 CFR 1.98

In the production of a round bar, the first step is to cut the timber into a square bar with a length and a square cross-section, and then the radial circumference of the square bar is cut to make a round bar with a circular cross-section.

The woodworking lathe can cut a large number of square bars into round bars rapidly. However, the woodworking lathe occupies considerable room, on the occasion without a woodworking lathe, the square bars cannot be cut into round bars by the woodworking lathe, when the woodworking lathe is used for processing, the part of the square bar which is clamped by the fixture of the woodworking lathe cannot be cut into a round bar. On the occasion of producing a small number of round bars, the woodworking lathe is less efficient in material utilization, and said production of a small number of round bars includes the production of dowels for mortise and tenon structures.

Further, if a square bar with a considerable length is cut into a round bar using a woodworking lathe, even if the square bar can be held far from the radial center of one end of the fixture by an ejector pin, when the woodworking lathe drives the square bar to rotate, the part between the two ends of the square bar is like to bend, influencing the cutting of the square bar.

### BRIEF SUMMARY OF THE INVENTION

The primary object of the present invention is to provide a round bar cutting device, which can be used to cut a square bar into a round bar.

In terms of the technical characteristics of problem solving of the present invention, the round bar cutting device includes a tool rest. The tool rest is axially penetrated by a perforation, the perforation allowing a round bar to pass through in axial direction. The tool rest has a front side and a back side. The perforation extends to the front side and the back side. A virtual axis is defined to pass through the radial center of the perforation in the extension direction of the perforation.

Four planer tools protrude forward from the front side. The planer tools are spaced apart around the axis. A first edge is formed on one side of each planer tool facing the axis, so as to cut a square bar which moves towards the perforation among the planer tools and rotates round the axis to form the round bar, and the round bar passes the back side and leaves the perforation.

The distance between each first edge and the axis in the diameter direction of the perforation increases from one end of each first edge close to the front side to the other end of each first edge, so as to guide the square bar to the midst of the first edges along the axis.

The present invention can fully cut the entire section of the square bar in the axial direction into the round bar, the material utilization efficiency of the square bar is increased.

### BRIEF DESCRIPTION OF THE SEVERAL VIEWS OF THE DRAWINGS

FIG. 1 is the stereogram of a preferred embodiment of the present invention.

FIG. 2 is the three-dimensional exploded diagram of a preferred embodiment of the present invention.

FIG. 3 is the stereogram of the tool rest in a preferred embodiment of the present invention.

FIG. 4 is the front view of the tool rest in a preferred embodiment of the present invention.

FIG. 5 is the 5-5 sectional view of FIG. 4.

FIG. 6 is the rear view of the tool rest in a preferred embodiment of the present invention.

FIG. 7 is the right side view of the tool rest in a preferred embodiment of the present invention.

FIG. 8 is the 8-8 sectional view of FIG. 7.

FIG. 9 is the three-dimensional diagram of the operating state in a preferred embodiment of the present invention.

FIG. 10 is the axial section view of the operating state in a preferred embodiment of the present invention.

FIG. 11 is the three-dimensional diagram of another operating state in a preferred embodiment of the present invention.

### DETAILED DESCRIPTION OF THE INVENTION

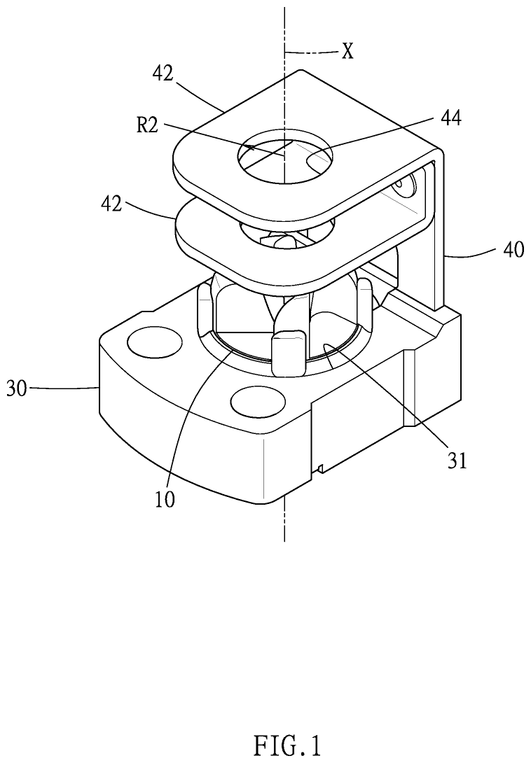

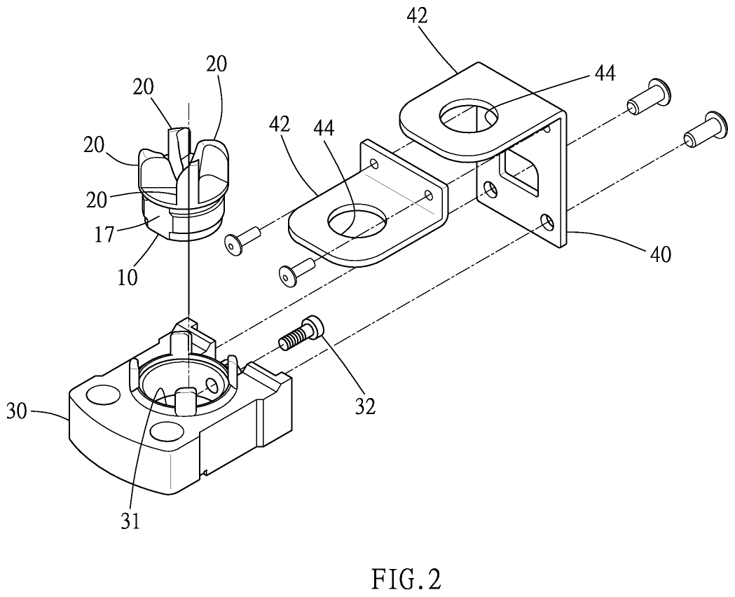

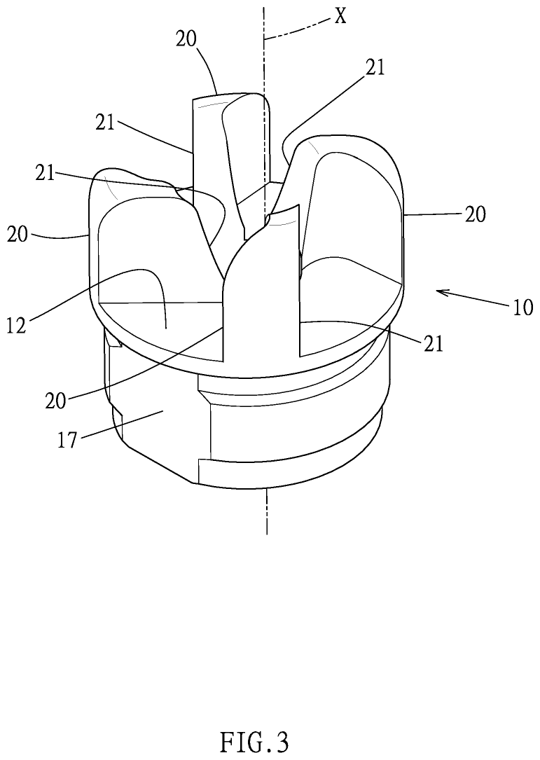

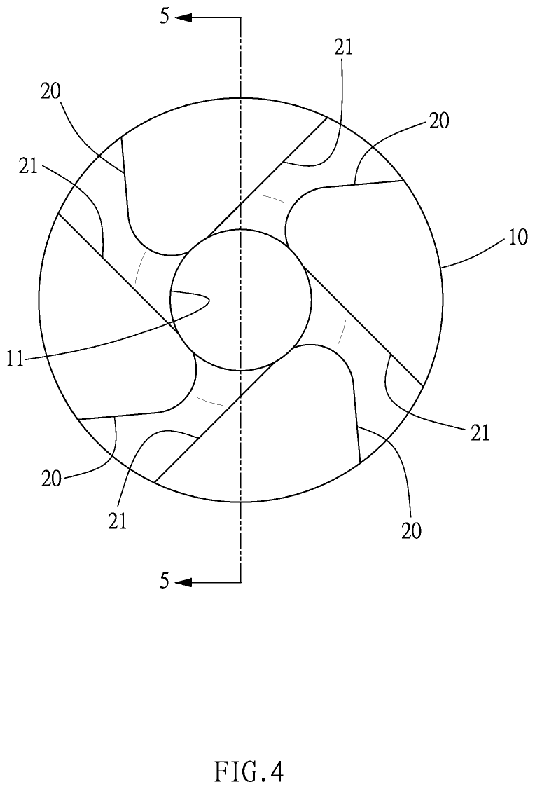

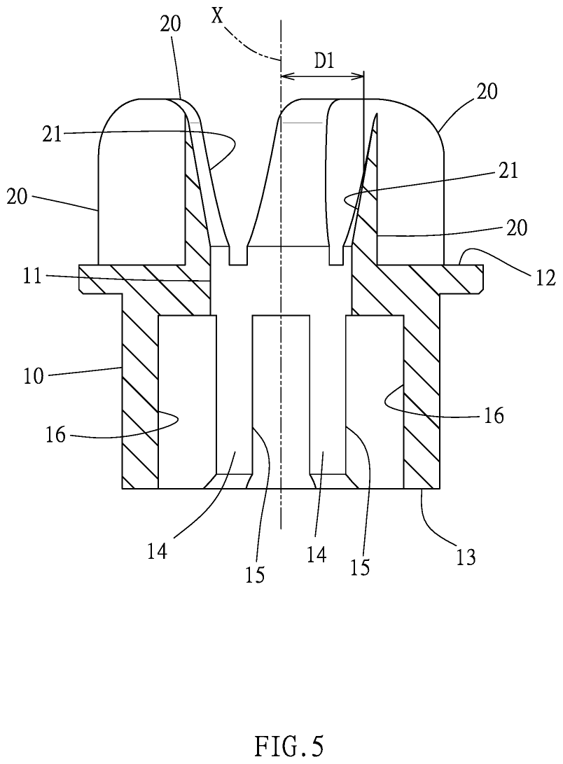

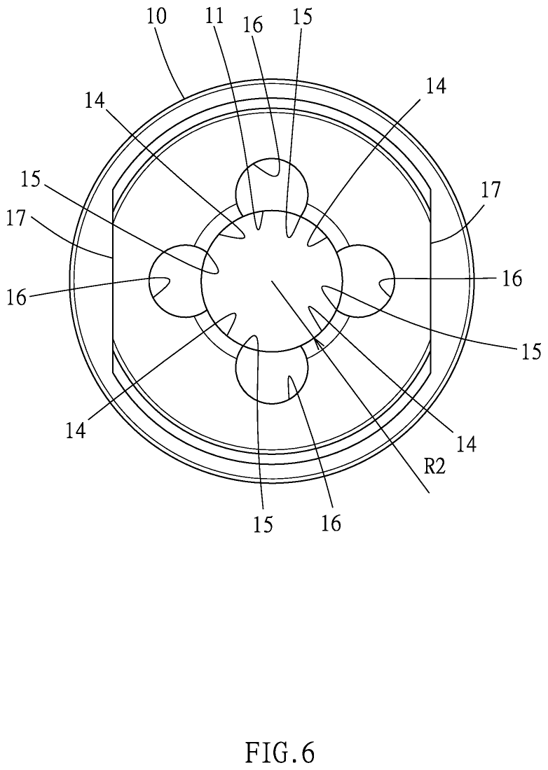

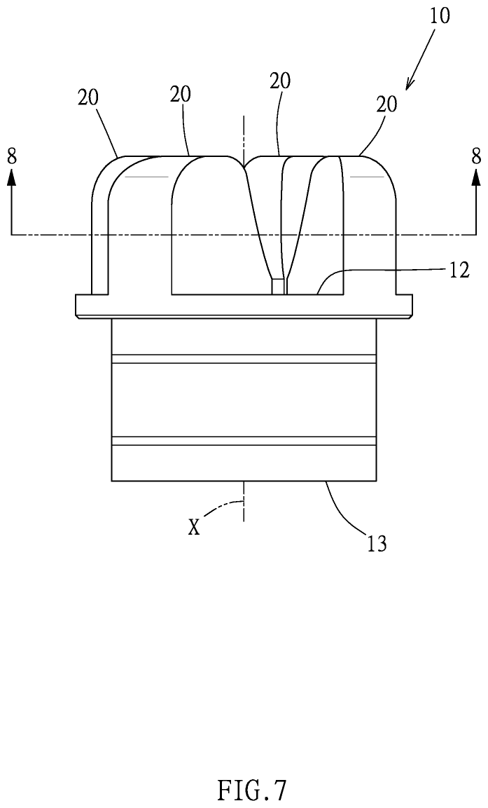

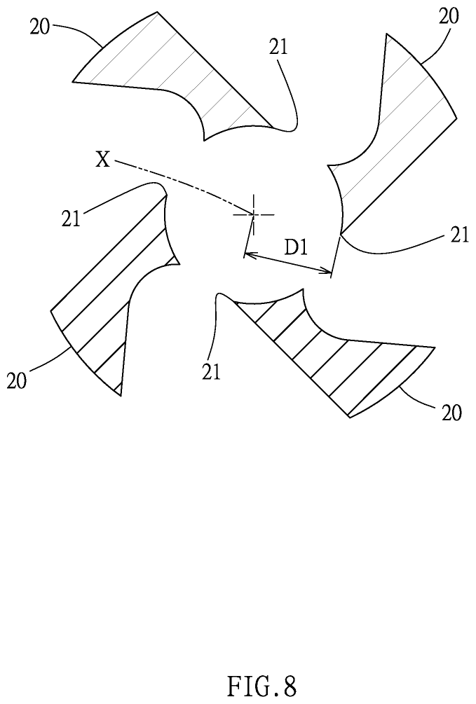

FIG. 1 to FIG. 8 show a preferred embodiment of the round bar cutting device of the present invention, including a tool rest 10. The tool rest 10 is axially penetrated by a perforation 11. The perforation 11 allows a round bar 91 to pass through in axial direction. The tool rest 10 has a front side 12 and a back side 13. The perforation 11 extends to the front side 12 and the back side 13. A virtual axis X is defined to pass through the radial center of the perforation 11 in the extension direction of the perforation 11.

Four planer tools 20 protrude forward from the front side 12. The planer tools 20 are spaced apart around the axis X. A first edge 21 is formed on one side of each planer tool 20 facing the axis, so as to cut a square bar 92 which moves towards the perforation 11 among the planer tools 20 and rotates round the axis X to form the round bar 91.

The distance D1 between each first edge 21 and the axis X in the diameter direction of the perforation 11 increases from one end of each first edge 21 close to the front side 12 to the other end of each first edge 21, so as to guide the square bar 92 to the midst of the first edges 21 along the axis X.

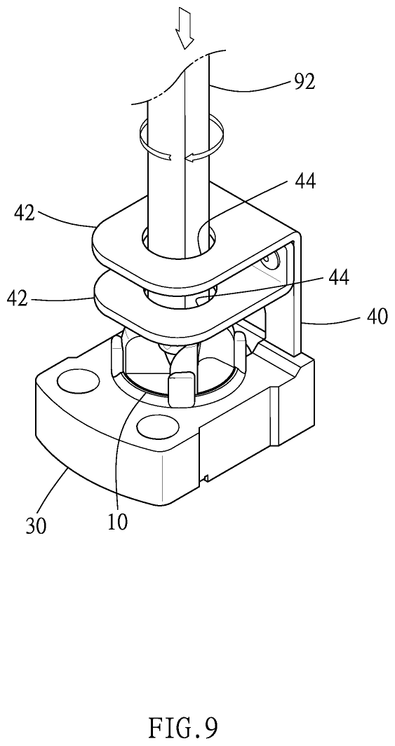

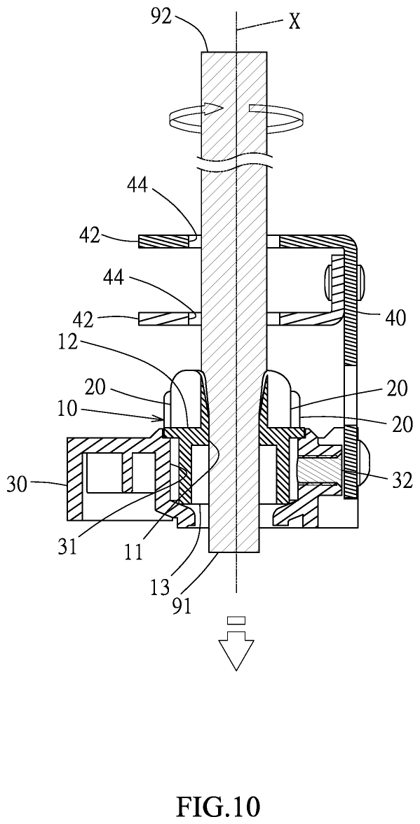

As shown in FIG. 9 and FIG. 10, when the square bar 92 with a square radial section is cut into the round bar 91 with a circular radial section using a preferred embodiment, the square bar 92 is pushed to the space surrounded by the planer tools 20 along the axis X, and the square bar 92 is rotated, so that the first edges 21 oppositely cut the radial periphery of the square bar 92. The chips resulted from the cutting of the square bar 92 (not shown in the figure) are discharged through the gap in the diameter direction of the tool rest 10 among the planer tools 20 spaced apart. The radial periphery of the square bar 92 is cut by the first edges 21 in turn. The round bar 91 with a circular radial section is formed gradually, and then the round bar 91 enters the perforation 11, and leaves the perforation 11 from the back side of the tool rest 10, the production of the round bar 91 is completed.

Said gap as the passage of the chips among the spaced planer tools 20 can temporarily hold the four corners of the radial periphery of the square bar 92 when the square bar 92 axially gets in the midst of the planer tools 20, so as to oppositely guide the axial direction of the square bar 92 to coincide with the axis X.

On the occasion without a woodworking lathe, the square bar 92 can be cut into the round bar 91 by using a preferred embodiment, and the square bar 92 may not be clamped by a fixture, the entire section of the square bar 92 in the axial direction can be fully made into the round bar 91. The material utilization efficiency of the square bar 92 is increased, especially on the occasion of producing a small number of the round bars 91, the material utilization efficiency of the square bar 92 is improved more significantly, said occasion of producing a small number of the round bars 91 includes the production of dowels for mortise and tenon structures.

In the process of cutting the square bar 92 into the round bar 91 using a preferred embodiment, none of the fixtures and ejector pins is required. The two axial ends of the square bar 92 are free from the compressive force towards the midsection of the square bar 92. The square bar 92 is unlikely to form lateral bending.

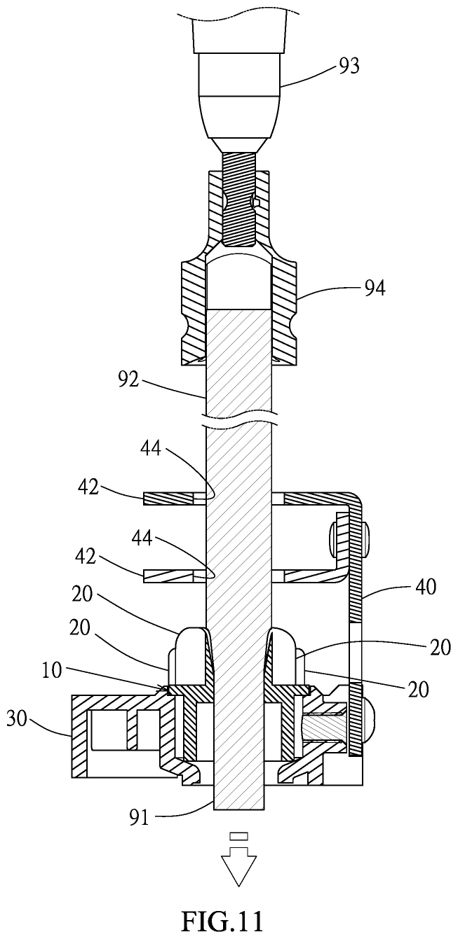

FIG. 11 illustrates the operating state of using an electric tool 93 to drive a sleeve 94, and the sleeve 94 is axially connected to the square bar 92. The operating state shown in FIG. 11 can rapidly and easily cut the square bar 92 into the round bar 91.

The number of the planer tools 20 can be changed according to the radial section of the pole to be cut, for example, the present invention can be changed to six planer tools 20, so as to cut a pole with a hexagonal radial section into the round bar 91.

The tool rest 10 forms several cambered hole walls 14 spaced apart around the perforation 11 on the axis X as the center. The hole walls 14 can help to keep the axis of the part with a circular radial section formed by the planer tools 20 on the axis X, contributing to keeping the axis of the square bar 92 among the planer tools 20 on the axis X.

A second edge 15 is formed on one side of each hole wall 14 in the circumferential direction of the perforation 11. The radius R1 between the second edges 15 and the axis X is smaller than the minimum value of the distance D1, so that the second edges 15 cut the radial periphery of the round bar 91, the preferred difference between the radius R1 and the minimum value of the distance D1 is 0.1-0.2 mm.

When the round bar 91 with a circular section cut out of the square bar 92 by the first edges 21 enters the perforation 11 surrounded by the hole walls 14, the second edges 15 form fine cutting with less cutting output on the radial periphery of the round bar 91, favorable for smoothing the radial periphery of the round bar 91.

The tool rest 10 forms several flutes 16. The flutes 16 extend to the back side 13. The second edges 15 are located on one side of the flutes 16 respectively. The flutes 16 provide the passages for discharging the chips produced after the round bar 91 is cut by the second edges 15 out of the tool rest 10 from the back side 13.

The preferred embodiment includes a mounting base 30. The mounting base 30 is penetrated by a mounting hole 31. The tool rest 10 is arranged in the mounting hole 31, so that the mounting base 30 can be fixed to a work table with fixtures, bolts or other positioning tools (not shown in the figure), and according to the size requirements of the round bar 91 and the square bar 92, the tool rest 10 with corresponding specifications for the planer tools 20 is configured on the mounting base 30.

Two planes 17 are formed on the radial periphery of the tool rest 10. A propping bolt 32 is screwed in the mounting base 30. The propping bolt 32 props one of the planes 17, so as to position the tool rest 10, in the process of cutting the square bar 92 into the round bar 91, the relative force of the square bar 92 on the planer tools 20 cannot drive the tool rest 10 to rotate with the square bar 92.

The number of the planes 17 can be changed as required, but there shall be at least one plane 17 for the propping bolt 32 to prop, so as to limit the rotation of the tool rest 10.

The preferred embodiment includes a guide piece 40. One end of the guide piece 40 is connected to the mounting base 30. The guide piece 40 is provided with two guide plates 42 towards the front side of the tool rest 10. A guide hole 44 penetrates the guide plates 42 along the axis X respectively. The axis X passes through the radial center of the guide holes 44, and the distance D1 is smaller than or equal to the radius R2 of the guide hole 44.

The number of the guide plates 42 penetrated by the guide hole 44 can be changed as required, but there shall be at least one guide plate 42. The square bar 92 passes through the guide hole 44 and gets in the midst of the planer tools 20. The guide hole 44 surrounds the radial periphery of the square bar 92, so as to avoid an excessively large oblique intersection between the axial direction of the square bar 92 and the axis X, contributing to guiding the axial direction of the square bar 92 to coincide with the axis X.

The guide plate 42 can be removed or changed, so as to change the guide piece 40 with the guide hole 44 of the radius R2 according to the size of the square bar 92.

I claim:

1. A round bar cutting device, including a tool rest, the tool rest is axially penetrated by a perforation, the perforation allows a round bar to pass through in axial direction, the tool rest has a front side and a back side, the perforation extends to the front side and the back side, a virtual axis is defined to pass through the radial center of the perforation in the extension direction of the perforation;
four planer tools protrude forward from the front side, the planer tools are spaced apart around the axis as the center, a first edge is formed on one side of each planer tool facing the axis X, so as to cut a square bar which moves towards the perforation among the planer tools and rotates round the axis to form the round bar, the round bar passes through the back side and leaves the perforation;
the distance between each first edge and the axis in the diameter direction of the perforation increases from one end of each first edge close to the front side to the other end of each first edge, so as to guide the square bar to the midst of the first edges along the axis.

2. The round bar cutting device defined in claim 1, wherein the tool rest forms several cambered hole walls spaced apart around the perforation on the axis.

3. The round bar cutting device defined in claim 2, wherein a second edge is formed on one side of each hole wall in the circumferential direction of the perforation, the radius between the second edges and the axis is smaller than the minimum value of the distance, so that the second edges cut the radial periphery of the round bar.

4. The round bar cutting device defined in claim 3, wherein the tool rest forms several flutes, the flutes extend to the back side, the second edges are located on one side of the flutes respectively.

5. The round bar cutting device defined in claim 1, including a mounting base, the mounting base is penetrated by a mounting hole, the tool rest is disposed in the mounting hole.

6. The round bar cutting device defined in claim 5, wherein a plane is formed on the radial periphery of the tool rest, a propping bolt is screwed in the mounting base, the propping bolt props the plane, so as to position the tool rest.

7. The round bar cutting device defined in claim 5, including a guide piece, one end of the guide piece is connected to the mounting base, the guide piece is provided with a guide plate towards the front side of the tool rest, the guide plate is penetrated by a guide hole along the axis, the axis passes through the radial center of the guide hole, and the distance is smaller than or equal to the radius R2 of the guide hole.
